(19) United States
(12) Patent Application Publication
(10) Pub. No.: US 2014/0095132 A1
(43) Pub. Date: Apr. 3, 2014

(54) SYSTEM AND METHOD FOR RATING COMPUTER MODEL RELATIVE TO EMPIRICAL RESULTS FOR DYNAMIC SYSTEMS

(71) Applicant: FORD GLOBAL TECHNOLOGIES, LLC, Dearborn, MI (US)

(72) Inventors: Yan Fu, Canton, MI (US); Ren-Jye Yang, Troy, MI (US); Saeed David Barbat, Novi, MI (US)

(73) Assignee: FORD GLOBAL TECHNOLOGIES, LLC, Dearborn, MI (US)

(21) Appl. No.: 13/632,795

(22) Filed: Oct. 1, 2012

(51) Int. Cl. G06G 7/48

(52) U.S. Cl. 703/6

(57) ABSTRACT

An objective metric for a computer model of a dynamic system includes time-shifting computer generated data relative to empirical test data and computing an associated cross-correlation for each time shifted data set, determining phase and slope errors and scores based on the time shifted data set that provides a maximum cross-correlation, determining a magnitude error and score by performing dynamic time warping on the maximum cross-correlation time shifted data set using a cost function based only on distance. The metric is a weighted combination of the magnitude, phase, and slope scored. An auto-calibration of metric parameters may include comparison of subjective ratings stored in a corresponding database in a computer readable storage device that includes data representing similarity between representative empirical data sets and computer generated data sets. Metric parameters may be tuned or optimized so that the objective metric corresponds to subjective ratings by subject matter experts.

### TECHNICAL FIELD

The present disclosure relates to systems and methods for rating computer model output for a dynamic system relative to empirical results for the dynamic system.

### BACKGROUND

Computer aided engineering (CAE) has become a vital tool in reducing vehicle prototype tests and shortening product development time. One goal of CAE is to reduce or eliminate the extensive physical prototype testing currently relied upon for various types of certifications, such as safety certifications for automotive systems, for example. Before utilizing computer models in product development for various vehicle dynamic systems, the quality, reliability, and predictive capabilities of the computer models must be assessed quantitatively and systematically. In addition, one of the key difficulties for model validation of dynamic systems is that most of the responses are functional responses that may be represented by time history curves, for example. This calls for the development of an objective metric that can assess the differences of both the time history associated with key features, such as phase shift, magnitude, and slope between empirical test curves and model predictions.

A previous metric, “Error Assessment of Response Time Histories (EARTH)” provides three independent measures to evaluate the predicted results of a computer model relative to empirical data associated with the key features of the functional responses, such as phase error, magnitude error, and slope error, that represent the physical characteristics of the response. This metric uses dynamic time warping to reduce the interactions among the three types of errors that measure the discrepancy between time histories of empirical data relative to model predictions, and has a smaller number of metric tuning parameters relative to many other metrics. Because the ranges of the three errors may be quite different and there is no single rating that can provide a quantitative assessment alone, the initial EARTH metric employs a linear regression method to combine the three errors into one score. A numerical optimization method is employed to identify the linear coefficients so that the resulting EARTH rating can match closely with subjective ratings of experts in the field for a specific application. However, the linear combination of the component errors in the EARTH metric is mainly numerical-based and application dependent; and therefore may not be scalable to other applications. In addition, a sensitivity study of the EARTH metric indicates that the EARTH metric does not provide desired robustness for some applications with respect to the number of samples used in the evaluation. In particular, the magnitude and slope errors change significantly based on the number of samples used in the analysis.

### SUMMARY

A computer system and computer-implemented method executed on a computer system for determining an objective metric for a computer model of a dynamic system based on an analysis of computer generated data relative to empirical test data stored in a computer readable storage device include time-shifting the computer generated data relative to the empirical test data and computing an associated cross-correlation for each time shifted data set, determining a phase error and phase score based on the time shifted data set that provides a maximum cross-correlation, performing dynamic time warping on the maximum cross-correlation time shifted data set using a cost function based only on distance between associated data points of the time shifted data set and test data and determining an associated magnitude error and magnitude score, determining a slope error and slope score based on the maximum correlation time shifted data set and the test data, and combining the phase score, the magnitude score, and the slope score to determine the objective metric for the computer model. In various embodiments, the system and method may also include auto-calibration of metric parameters. The auto-calibration may include comparison of subjective ratings stored in a corresponding database in a computer readable storage device that includes data representing similarity between representative empirical data sets and computer generated data sets. Metric parameters may be tuned or optimized so that the objective metric corresponds to subjective ratings by subject matter experts.

In one embodiment a computer system and computer-implemented method executed on a computer system perform dynamic time warping on test data and computer generated data to determine a magnitude error and magnitude score using a cost function that includes only zero order derivatives, i.e. does not rely on the slope or topology of the test data curve and computer generated data curve. A slope error is determined by dividing the time (phase) shifted computer generated data into multiple intervals each having a plurality of data points and calculating the average slopes of each interval to generate slope curves without using dynamic time warping. A slope score is determined using metric parameters to assign a score between zero and unity or equivalent percentages.

Various embodiments according to the present disclosure provide associated advantages. For example, systems and methods according to embodiments of the present disclosure may be used to quantitatively assess the accuracy and predictive capacity of a computer model of a dynamic system with multiple responses. The systems and methods quantify error associated with phase, magnitude, and shape (slope) independently using dynamic time warping to minimize the effect of localized phase and topology while measuring magnitude and topological error. Magnitude error is calculated using a cost function that is robust with respect to the number of samples used. The different error measures are combined to provide an overall error measure and a single intuitive score for the computer model relative to the selected application. The metric uses a small set of parameters that have associated physical corollaries to facilitate subject matter experts' subjective analysis through a parameter calibration process to determine thresholds, and is scalable to different applications.

### BRIEF DESCRIPTION OF THE DRAWINGS

FIG. 1 is a block diagram illustrating operation of a system or method for determining an objective rating for computer model data relative to empirical test data according to a representative embodiment of the present disclosure;

FIG. 2 is a block diagram illustrating operation of a system or method for auto-calibration of metric parameters according to a representative embodiment of the present disclosure; and

FIG. 3 is a block diagram illustrating a representative system for auto-calibration of metric parameters and determination of an objective metric according to representative embodiments of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present inventors recognized that the prior art EARTH metric used to evaluate computer models relative to empirical data was not robust, with results varying for different numbers of samples in the empirical data set. A number of other robustness issues were also identified. For example, the linear fitting used in the EARTH metric to calculate slope curves may introduce approximation error. The Dynamic Time Warping (DTW) path is sensitive to different data interpolation because it uses both distance and slope components in the cost function calculation. In addition, conducting DTW to slope curves may reduce or eliminate local shape differences, the slope error calculation is too sensitive to the number of data points, and the slope score does not correlate well with subjective evaluations of subject matter experts.

Embodiments according to the present disclosure provide systems and methods for rating a computer model relative to empirical results for dynamic systems that maintain the advantages of the EARTH metric while providing a number of advantages. In addition to the previously described advantages, the enhanced EARTH (EEARTH) metric is more robust and provides consistent magnitude and slope ratings with better correlation to subjective ratings provided by subject matter experts.

The EARTH metric is divided into two categories: global response error and target point response error. The global response error is defined as the error associated with the complete time history with equal weight on each point. The three main components of the global response error are phase error, magnitude error, and topology (or slope) error. The target point error is defined as the error associated with a certain localized phenomenon of interest, such as peak error and time-to-peak error. The target point error represents the characteristic of a part of the time history, but does not indicate an overall performance of the entire time history. In addition, the target point error is generally application dependent and therefore it is not described in detail.

Separately quantifying the errors associated with phase, magnitude and topology/slope is challenging because they are not independent and have significant interactions. For example, to quantify the error associated with magnitude, the presence of a phase difference between the time histories may result in a misleading measurement. A unique feature of the EARTH metric is employing a known technique of dynamic time warping (DTW) to separate the interaction of phase, magnitude, and topology/slope errors. DTW is an algorithm for measuring discrepancy between time histories. It aligns peaks and valleys as much as possible by expanding and compressing the time axis according to a cost (distance) function. As recognized by the present inventors, the cost function specified for the DTW algorithm used in the EARTH metric, in addition to the method employed to calculate the magnitude and slope errors may contribute to a lack of robustness, particularly with respect to sensitivity to the number of samples.

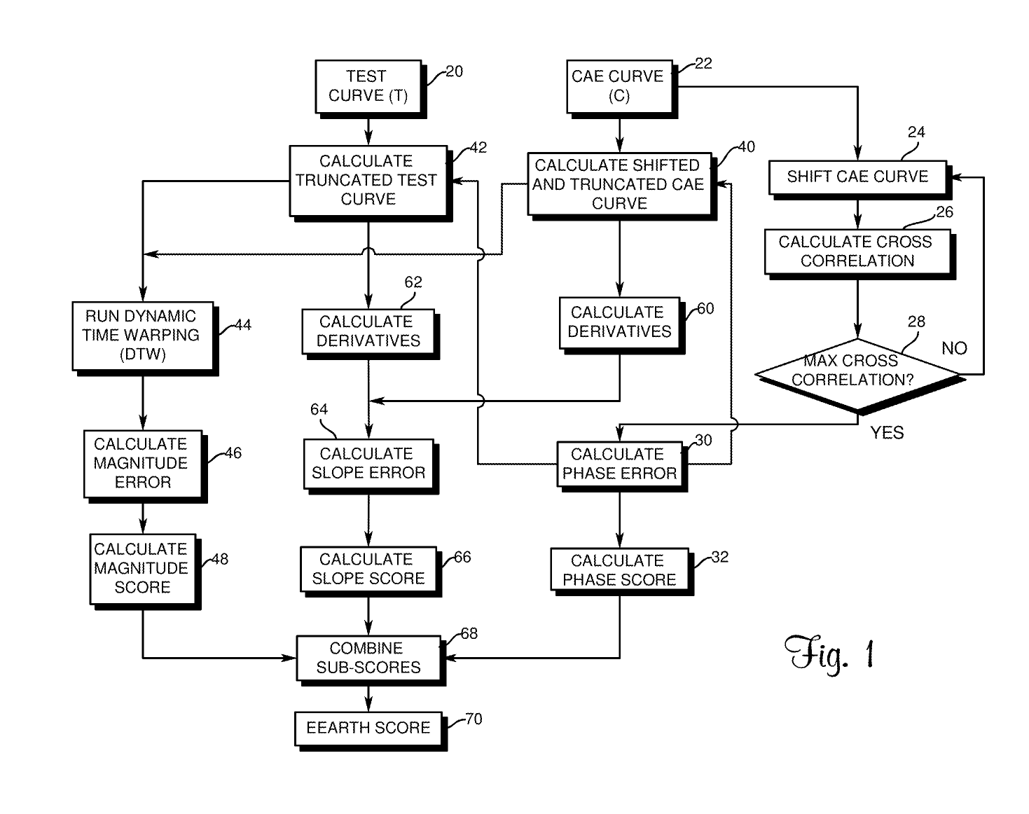

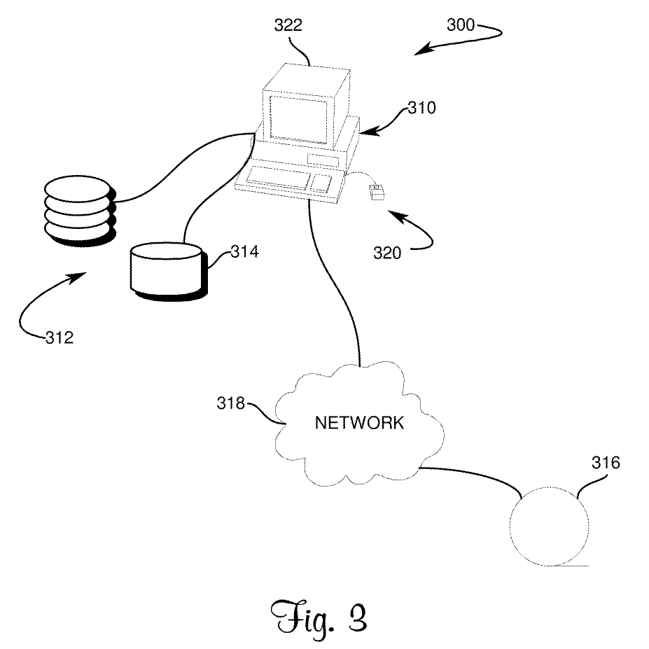

A block diagram illustrating operation of a system or method for rating computer model data relative to empirical data for dynamic systems according to embodiments of the present disclosure is shown in FIG. 1. The system and method may be implemented by a computer having a microprocessor in communication with one or more computer readable storage devices as generally illustrated and described with reference to FIG. 3. As those of ordinary skill in the art will understand, the functions represented by the block diagram or flow chart may be performed by software and/or hardware. Depending upon the particular processing strategy, the various functions may be performed in an order or sequence other than illustrated in the Figures. Similarly, one or more steps or functions may be repeatedly performed, although not explicitly illustrated. In one embodiment, the functions illustrated are primarily implemented by software, instructions, or code stored in a computer readable storage device and executed by a microprocessor-based computer. Data may be stored locally on a computer readable storage device or may be accessed over a local or wide area network, such as the internet, for example. The system may include various sensors or transducers, such as accelerometers, for example, to collect empirical data from a corresponding test or experiment, generally referred to as test data. The test data is compared to computer mode data, generally referred to as CAE data, to provide a metric or score that represents how well the CAE data generated by an associated computer model of the dynamic system represents the test data.

Block 20 represents the original empirical or test data (T), while block 22 represents the original computer model data or CAE data (C). The empirical data is collected from sensors or transducers, such as accelerometers or force sensors, for example, with the signals from the sensors gathered during an experiment or test. For example, crash test data may include data from multiple sensors collected during a crash test to measure force/acceleration for head, neck, and chest of a crash test dummy. A computer model of a corresponding simulated crash is used to generate CAE data 22. The data is pre-processed so that both empirical data 20 and model data 22 have similar measurement characteristics, such as sampling rate, filtering, etc. In one embodiment, both data sets are represented as non-ambiguous curves (e.g.: time-history curves), and both signals are synchronized with respect to the physical meanings of the signal's characteristics so that both signals are aligned by physical meanings and timing. In addition, for each time step of the reference signal, a value of the analyzed signal should be provided with both signals assessed at their common sampling points. The signals should also use the same system of units.

In one embodiment, a sampling rate of 10 kHz is used for the data signals 20, 22 for analysis using the algorithm described herein. Signals of higher or lower sampling rates may be re-sampled to this rate as part of the pre-processing. Those of ordinary skill in the art will recognize that the EEARTH metric may also work with other sampling rates. However, the tuning parameters may need to be adjusted accordingly, and the score interpretation may be affected.

Because the metric calculations could be difficult when using very noisy signals, data collection and/or pre-processing may include filtering of the signals. In addition, the assessment of the correlation should be focused on the relevant parts of the given signals. For automotive safety applications, such as vehicle crash tests, signals may include pre-crash and post-crash phases that are usually not of interest and should be excluded from the metric. Therefore, an interval of evaluation should be selected that describes the part of the signals of interest to be assessed.

With continuing reference to FIG. 1, the original CAE curve 22 is shifted one step at a time towards or away from the original test data 20 as represented by block 24. The cross correlation is calculated as represented by block 26. In this step, the initial curve 22 (C) is shifted left then right (or forward and back in time) one step at a time relative to the original test data 20 (T), and the cross correlation between is calculated until reaching the maximum allowable time shift limits ε_{P}*·(t_{end}−tₛₜₐᵣₜ). When the initial curve C is moved to the left by m time steps, the number of overlap points of the two time histories after time shift n is reduced to (N−m) where N represents the total number of time steps and the corresponding cross correlation value ρ_{L}(m) is calculated according to:

$${ρ}_{L} ( m ) = \frac{{\sum }_{i = 0}^{n - 1} [ ( C ( {t}_{start} + ( m + i ) \cdot Δ t ) - \overline{C} ( t ) ) \cdot ( T ( {t}_{start} + i \cdot Δ t ) - \overline{T} ( t ) ) ]}{\begin{matrix}\sqrt{{\sum }_{i = 0}^{n - 1} {[ C ( {t}_{start} + ( m + i ) \cdot Δ t ) - \overline{C} ( t ) ]}^{2}} \cdot \\ \sqrt{{\sum }_{i = 0}^{n - 1} {[ T ( {t}_{start} + i \cdot Δ t ) - \overline{T} ( t ) ]}^{2}}\end{matrix}}$$

When the original C curve is moved to the right by m time steps, the number of overlap points after time shift n is reduced to (N−m) and the corresponding cross correlation value ρ_{R}(m) is calculated according to:

$${ρ}_{R} ( m ) = \frac{{\sum }_{i = 0}^{n - 1} [ ( C ( {t}_{start} + i \cdot Δ t ) - \overline{C} ( t ) ) \cdot ( T ( {t}_{start} + ( m + i ) \cdot Δ t ) - \overline{T} ( t ) ) ]}{\begin{matrix}\sqrt{{\sum }_{i = 0}^{n - 1} {[ C ( {t}_{start} + i \cdot Δ t ) - \overline{C} ( t ) ]}^{2}} \cdot \\ \sqrt{{\sum }_{i = 0}^{n - 1} {[ T ( {t}_{start} + ( m + i ) \cdot Δ t ) - \overline{T} ( t ) ]}^{2}}\end{matrix}}$$

This is repeated to determine the maximum or best cross correlation between test curve 20 and computer model curve 22 as generally represented by block 28. The maximum cross correlation ρ_{E} is the maximum of all ρ_{L}(m) and ρ_{R}(m). The number of the time shifting steps that yields the maximum cross correlation ρ_{E} is defined as the phase error n_{ε} as represented by block 30. The corresponding shifted and truncated CAE curve C is recorded as C^{ts} and represented by block 40, and the corresponding truncated test curve is recorded as T^{ts} and represented block 42.

The phase error determined at block 30 is then used to calculate the phase score as represented by block 32. The phase score may be calculated or determined according to the following:

$${E}_{P} = [ \begin{matrix}100 \% & {n}_{ɛ} = 0 \\ 0 \% & {n}_{ɛ} \geq {ɛ}_{p}^{*} \times n \\ {( \frac{{ɛ}_{p}^{*} \times n - {n}_{ɛ}}{{ɛ}_{p}^{*} \times n} )}^{{K}_{{E}_{P}}} & otherwise\end{matrix} \\ {K}_{{E}_{P}} ∈ \{ 1 , 2 , 3 … \}$$

where the allowable time shift threshold parameters and corresponding representative values for a typical application are represented by:
εₚ*=0.2
K_{E}_{_{P}}=1
   The time shift threshold parameters may be selected from a database of values stored in the computer readable storage device. The database may contain metric parameter values as determined during a calibration process using subjective evaluations by subject matter experts (SME's) as described in greater detail below. The above method of determining the phase score used in the EEARTH metric provides a best phase score of 100%, which means there is no need to shift CAE data 22 to reach the maximum correlation coefficient between the original test data 20 and CAE data 22. However, if the shift is equal to or greater than the maximum allowable time shift threshold, then the EEARTH phase score is 0%. For any values in between, the EEARTH phase score may be calculated using the regression method shown above, for example.

As also represented in FIG. 1, the shifted and truncated CAE curve 40 and the truncated test curve 42 are used to perform dynamic time warping (DTW) as represented by block 44. DTW is a known algorithm for measuring discrepancies between time histories and has been used in various signal matching applications, such as speech recognition, stock or commodity price sequences, for example. It aligns peaks and valleys as much as possible by expanding and compressing the time axis according to a given cost (distance) function. The key idea of DTW is that any point of a time history can be (forward and/or backward) aligned with multiple points of the other time history that lie in different temporal positions, so as to compensate for temporal shifts. DTW is used in various embodiments according to the present disclosure to separate or isolate the interaction among the phase, magnitude, and slope errors.

The magnitude error is a measure of discrepancy in the amplitude of the time histories of the test curve 20 and computer model curve 22. The magnitude error is defined as the difference in amplitude of the two time histories when there is no time lag between them. Before calculating the magnitude error as represented by block 46, the difference between the time histories caused by error in phase and topology/slope are minimized by using dynamic time warping as represented by block 44. The initial EARTH metric magnitude scores changed significantly when the number of the sample points was reduced from 2000 to 250. Further investigation identified that the local cost function of the dynamic time warping involving both the distance and the slope, was the main cause of this significant change in the magnitude score. As such, the EEARTH calculation according to embodiments of the present disclosure uses the following local cost function, which is less sensitive or more robust to the number of samples used in the calculation:

d(i,j)=(C^{ts}(i)−T^{ts}(j))²

The cost function is used to generate a local cost matrix that is stored in the computer readable storage device. The cost matrix is used by the DTW algorithm to find the alignment path that runs through the low-cost areas in the cost matrix. This alignment path defines the correspondence of elements of both C^{ts} (i) and T^{ts} (j) that will lead to the minimum accumulated cost function. The magnitude error ε_{mag} is then calculated as represented by block 46 according to:

$${ɛ}_{mag} = \frac{{‖ {C}^{ts + w} - {T}^{ts + w} ‖}_{1}}{{\vert {T}^{ts + w} ‖}_{1}}$$

The magnitude error is then used to calculate the magnitude score as represented by block 48 according to:

$${E}_{M} = [ \begin{matrix}100 \% & {ɛ}_{magitude} = 0 \\ 0 & {ɛ}_{magitude} \geq {ɛ}_{m}^{*} \\ {( \frac{{ɛ}_{m}^{*} - {ɛ}_{magnitude}}{{ɛ}_{m}^{*}} )}^{{K}_{{E}_{m}}} & otherwise\end{matrix} , \\ {K}_{{E}_{m}} ∈ \{ 1 , 2 , 3 … \} \\ {ɛ}_{m}^{*} = 0.5 \\ {K}_{{E}_{M}} = 1$$

The magnitude score is represented E_{M} where εₘ* is the maximum allowable magnitude error, and K_{E}_{_{M}} defines the order of the regression. In this way, the best EEARTH magnitude score is 100%, which means there is no difference between the amplitudes after phase shifting and dynamic time warping. If the original EARTH magnitude error is equal to or greater than the maximum allowable magnitude error threshold, then the EEARTH magnitude score is 0%. For values in between these constraints, the EEARTH magnitude score is calculated using a regression method as shown above. Similar to the phase score, the metric calibration parameters, thresholds, or constraints may be stored in a database of values stored in the computer readable storage device. The database may contain metric parameter values as determined during a calibration process using subjective evaluations by subject matter experts (SME's) as described in greater detail below.

The topological or slope error is a measure of discrepancy in topology/slope of the test curve 20 and computer model curve 22. The topology/slope of a time history is defined by the slope at each point. To ensure that the effect of global time shift is minimized, the slope is calculated from the truncated time shifted histories T^{ts} and C^{ts} as generally represented by blocks 40 and 42 of FIG. 1. Thus, by taking the derivative at each point the derivative time shifted histories, represented by T^{ts+d} and C^{ts+d}, are obtained as represented by blocks 60 and 62, respectively.

The inventors of the present disclosure recognized that the EARTH slope scores were also affected by, or sensitive to, different sampling rates. This sensitivity was determined to be due to the implementation of the slope curve calculation and using dynamic time warping on these slope curves before calculating the EARTH slope error. In the initial EARTH metric, a polynomial fitting was first employed to smooth the time shifted histories T^{ts} and C^{ts}, and then the derivative curves (C^{ts+d} and T^{ts+d}) were calculated from the polynomial fitting curves. The polynomial fitting is an approximation method, so it can introduce variation into the metric. In addition, dynamic time warping was performed on the resulting slope curves before calculating the slope error. The inventors noted that DTW used here could reduce the slope differences and the EARTH slope score may not be able to differentiate between the good or poor correlations.

In the EEARTH metric according to embodiments of the present disclosure, the time shifted histories T^{ts} and C^{ts} are first divided into multiple intervals with pre-defined length/time based on the sampling rate (e.g. 1 ms) so that each interval includes multiple data points. Next, average slope is calculated in each interval to generate slope curves (C^{ts+d} and T^{ts+d}) as represented by blocks 60 and 62. Therefore, the slope curves are used to calculate the slope error directly without performing dynamic time warping.

The slope error is then calculated based on the slope curves as represented by block 64 according to:

$${ɛ}_{slope} = \frac{{‖ {C}^{ts + d + w} - {T}^{ts + d + w} ‖}_{1}}{{‖ {T}^{ts + d + w} ‖}_{1}}$$

The slope error is then used to calculate the slope score as represented by block 66 according to:

$${E}_{S} = [ \begin{matrix}100 \% & {ɛ}_{slope} = 0 \\ 0 & {ɛ}_{slope} \geq {ɛ}_{s}^{*} , \\ {( \frac{{ɛ}_{s}^{*} - {ɛ}_{slope}}{{ɛ}_{s}^{*}} )}^{{K}_{{E}_{s}}} & otherwise\end{matrix} , \\ {K}_{{E}_{s}} ∈ \{ 1 , 2 , 3 … \} \\ {ɛ}_{S}^{*} = 2.0 \\ {K}_{{E}_{S}} = 1$$

The slope score is determined in a similar manner as the magnitude score as previously described. The maximum allowable slope error defines the order of the regression. In this way, the best EEARTH slope score is 100%, which means there is no difference between the two slope curves. If the slope error is equal to or greater than the maximum allowable slope error threshold or constraint, then the EEARTH slope score is 0%. For values in between, the EEARTH slope score is calculated by the regression method shown. Similar to the magnitude and phase scores, the metric calibration parameters, thresholds, or constraints may be obtained from a database of values stored in the computer readable storage device. The database may contain metric parameter values as determined during a calibration process using subjective evaluations by subject matter experts (SME's) as described in greater detail below.

As such, the EEARTH metric according to embodiments of the present disclosure improves robustness by reducing sensitivity of the slope error and slope score to the number of samples by (1) dividing the phase shifted curves into multiple intervals with pre-defined length each having multiple data points, (2) calculating average slopes of each intervals to generate slope curves, and (3) calculating the slope error without the use of dynamic time warping. Analysis reveals that the EEARTH metric slope ratings are not significantly affected by changes in the sampling rates and better correspond with subjective ratings of subject matter experts as compared with the original EARTH metric.

The three EEARTH sub-scores for the phase 32, magnitude 48, and slope 66 are combined using associated weighting factors as represented by block 68 according to:

E=w_{P}·E_{P}+w_{M}·E_{M}+w_{S}·E_{S}

The weighting factors may vary depending on the particular application and may be determined in a similar fashion as other metric calibration parameters by subject matter experts for a particular application. In one representative embodiment, equal weighting factors of ⅓ are applied to the sub-scores to generate a single EEARTH score metric as represented by block 70. Depending on the particular application, the single EEARTH score metric may be further combined with one or more other metrics to rate the computer model performance relative to empirical data for a particular dynamic system.

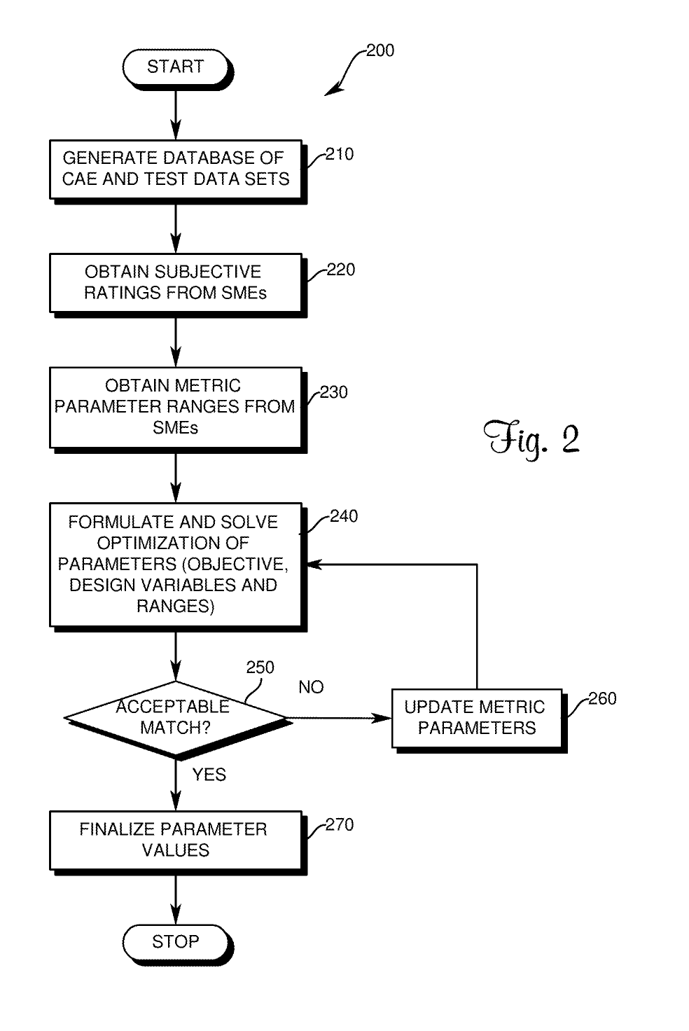

FIG. 2 is a block diagram illustrating metric parameter calibration according to a representative embodiment of the present disclosure. Similar to the block diagram of FIG. 1, block diagram 200 generally represents a computer-implemented process with various functions illustrated being performed using a programmed computer executing instructions stored in a computer readable storage device to automatically tune or calibrate one or more parameters associated with a metric used to evaluate computer model data relative to empirical data for a dynamic system as described herein. The process incorporates physical-based thresholds and subjective evaluations of subject matter experts to provide a desired range of scores that correspond to the ability of the computer model to accurately predict corresponding test data.

The auto-tuning or auto-calibration process begins with generating a representative dynamic response database as represented by block 210. A set of representative dynamic responses with test data and computer model data is stored in the database with the database being stored in one or more computer readable storage devices as described with reference to FIG. 3. The dynamic responses represented in database 210 may include different types of responses, such as moment, force, displacement, and acceleration, for example. In addition, the response may also cover a wide range of computer model quality with respect to how well the computer model data predicts or matches the corresponding empirical test data.

Block 220 of FIG. 2 represents survey results generated by subject matter experts (SMEs) that correspond to a subjective rating of how well a particular test data set matches corresponding output from one or more computer models. A group of SMEs is surveyed to collect the SME rating data. The survey results are then processed by the system using any of a number of statistical or mathematical operations. In one embodiment, the mean of the SME scores serves as the basis for calibrating the EEARTH metric parameters so that the objective ratings of the EEARTH metric reflect the knowledge base of the sampled SMEs. The SME survey data may also include potential ranges of the enhanced EARTH metric parameter values as generally represented by block 230. Because the EEARTH was developed with parameters that have clear physical-based corollaries, SMEs can provide potential ranges of them based on experience and knowledge of empirical test data. Representative metric parameters that may have values or ranges selected or tuned may include the order of the phase metric, the order of the magnitude metric, the order of the slope metric, the phase score weighting factor, the magnitude score weighting factor, the slope score weighting factor, the maximum percentage or multiplier for the time shift, the maximum magnitude error, and maximum slope error, for example.

An optimization goal with corresponding constraints for the EEARTH metric auto calibration is formulated as generally represented by block 240. This may include defining an optimization objective and design variables and ranges for a particular application. Once a metric calibration goal is formulated, an optimization algorithm is employed to find the optimal values of the EEARTH metric parameters as represented by blocks 240, 250, and 260. The metric parameter values are calculated using the SME ratings database with the each result evaluated and determined to be acceptable or not for the particular application as represented by block 250. If the objective ratings of the EEARTH metric are not an acceptable match to the empirical data as determined by the subjective ratings of the SMEs as determined at block 250, then the parameter values are adjusted or updated as represented by block 260. This optimization loop continues until an acceptable set of parameter values is obtained. When acceptable parameter values are determined as represented by block 250, then the EEARTH metric parameter values are finalized as represented by block 270 and used in subsequent determination of the EEARTH metric score as described above.

FIG. 3 is a block diagram illustrating a representative embodiment of a computer system for executing a computer-implemented method for determining an objective metric for a computer model of a dynamic system based on an analysis of computer generated data relative to empirical test data stored in a computer readable storage device according to the present disclosure. System 300 includes a computer 310 in communication with one or more computer readable storage devices 312. Computer readable storage devices 312 may include any of a number of well-known permanent or persistent (non-transitory) storage devices for storing data and executable instructions, such as magnetic and/or optical tape or disks, flash memory, CDs, DVDs, and/or combination storage devices. Computer readable storage devices 312 may include one or more local devices 314 and/or remote devices 316 accessible over a local or wide area network 318, such as the internet, for example. Computer 310 includes one or more input devices 320 and output devices 322. Input devices 320 may include sensors or transducers that collect data from empirical tests of a dynamic system, such as accelerometers, force transducers, strain gages, and the like. Empirical test data may be stored in computer readable storage devices 312. Alternatively, empirical test data may be collected by a data acquisition system and preprocessed as described above with the test data transferred to system 300 via network 318. Computer readable storage devices 312 may also store computer generated data generated by a computer model of the dynamic system as previously described.

In one embodiment, system 300 includes a computer 310 configured to execute instructions and process data stored in computer readable storage devices 312 to determine an objective metric for a computer model of a dynamic system based on an analysis of computer generated data relative to empirical test data. Computer 310 includes software and/or hardware configured to time-shift the computer generated data relative to the empirical test data and compute an associated cross-correlation for each time shifted data set, determine a phase error and phase score based on the time shifted data set that provides a maximum cross-correlation, and perform dynamic time warping on the maximum cross-correlation time shifted data set using a cost function based only on distance between associated data points of the time shifted data set and test data and determine an associated magnitude error and magnitude score. Computer 310 may also be configured to determine a slope error and slope score based on the maximum correlation time shifted data set and the test data, combine the phase score, the magnitude score, and the slope score to determine the objective metric for the computer model.

As demonstrated by the representative embodiments according to the present disclosure, an objective metric such as the EEARTH metric provides various associated advantages relative to previous metrics used to evaluate computer generated test data. For example, systems and methods according to embodiments of the present disclosure may be used to quantitatively assess the accuracy and predictive capacity of a computer model of a dynamic system with multiple responses. The systems and methods quantify error associated with phase, magnitude, and shape (slope) independently using dynamic time warping to minimize the effect of localized phase and topology while measuring magnitude and topological error. Magnitude error is calculated using a cost function that is robust with respect to the number of samples used. The different error measures are combined to provide an overall error measure and a single intuitive score for the computer model relative to the selected application. The metric uses a small set of parameters that have associated physical corollaries to facilitate subject matter experts' subjective analysis through a parameter calibration process to determine thresholds, and is scalable to different applications.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for particular applications.

What is claimed is:

1. A computer-implemented method executed on a computer system for determining an objective metric for a computer model of a dynamic system based on an analysis of computer generated data relative to empirical test data stored in a computer readable storage device, the method comprising:
time-shifting the computer generated data relative to the empirical test data and computing an associated cross-correlation for each time shifted data set;
determining a phase error and phase score based on the time shifted data set that provides a maximum cross-correlation;
performing dynamic time warping on the maximum cross-correlation time shifted data set using a cost function based only on distance between associated data points of the time shifted data set and test data and determining an associated magnitude error and magnitude score;
determining a slope error and slope score based on the maximum correlation time shifted data set and the test data; and
combining the phase score, the magnitude score, and the slope score to determine the objective metric for the computer model.

2. The method of claim 1 wherein determining a phase error and phase score comprises determining a phase score of zero if the maximum cross-correlation time shifted data set corresponds to a time shift that exceeds a corresponding maximum allowable time shift metric parameter.

3. The method of claim 2 wherein the maximum allowable time shift metric parameter is determined by an auto-calibration process executed on the computer system that compares the computer generated data to the empirical test data using an associated plurality of subjective ratings stored in the computer readable storage device.

4. The method of claim 1 wherein determining a phase error and phase score comprises determining a phase score of 100 percent if the maximum cross-correlation time shifted data set corresponds to no time shift.

5. The method of claim 1 wherein determining a phase error and phase score comprises:
determining a phase score of zero if the time shifted data set that provides the maximum cross-correlation corresponds to a time shift that exceeds a corresponding maximum allowable time shift metric parameter;
determining a phase score of 100 percent if the maximum cross-correlation time shifted data corresponds to no time shift; and
otherwise determining a phase score based on a regression method.

6. The method of claim 1 wherein the phase score, the magnitude score, and the slope score are determined based on a corresponding phase error, magnitude error, and slope error, respectively, by:
determining a score of zero if the corresponding error exceeds an associated parameter maximum threshold value;
determining a score of 100% if the corresponding error is less than an associated parameter tolerance threshold value; and
otherwise determining a score based on the corresponding error using a regression method.

7. The method of claim 1 wherein combining the phase score, the magnitude score, and the slope score comprises applying a weighting factor to each score to generate corresponding weighted scores and summing the corresponding weighted scores to determine the objective metric.

8. The method of claim 7 wherein the weighting factor for each score is a constant.

9. The method of claim 7 wherein the objective metric ranges in value between zero and unity.

10. The method of claim 1 wherein determining the slope error comprises:
dividing the maximum cross-correlation time shifted data set into multiple intervals each having a plurality of data points;
calculating an average of slopes corresponding to each interval; and
determining the slope error based on the average of slopes.

11. A computer-implemented method executed by a computer, comprising:
time-shifting computer model generated data relative to test data and computing an associated cross-correlation for each time shifted data set; and
determining an error and score associated with a phase, magnitude, and slope of the time shifted data set, wherein the magnitude error and score are determined using a cost function independent of slope for data points of the time shifted data set and the test data.

12. The computer-implemented method of claim 10 further comprising combining the phase, magnitude, and slope scores to determine an objective metric for the computer model.

13. The computer-implemented method of claim 11 wherein the objective metric is based on a weighted sum of the phase, magnitude, and slope scores.

14. The computer-implemented method of claim 11 wherein determining an error associated with the slope comprises:
dividing the maximum cross-correlation time shifted data set into multiple intervals each having a plurality of data points;
calculating an average of slopes corresponding to each interval; and
determining the slope error based on the average of slopes.

15. The computer-implemented method of claim 14 wherein the phase score, the magnitude score, and the slope score are determined based on a corresponding phase error, magnitude error, and slope error, respectively, by:
determining a score of zero if the corresponding error exceeds an associated parameter maximum threshold value;
determining a score of 100% if the corresponding error is less than an associated parameter tolerance threshold value; and
otherwise determining a score based on the corresponding error using a regression method.

16. The computer-implemented method of claim 15 wherein the associated parameter maximum threshold value and the associated tolerance threshold value are determined by an auto-calibration process executed on the computer that compares the computer model generated data to the test data using an associated plurality of subjective ratings stored in a computer readable storage device in communication with the computer.

17. A computer system for executing a computer-implemented method for determining an objective metric for a computer model of a dynamic system based on an analysis of computer model generated data relative to empirical test data, the computer system comprising:
a computer readable storage device having the computer model generated data and the empirical test data stored therein; and
a processor in communication with the computer readable storage device, the processor configured to time-shift the computer model generated data relative to the empirical test data and compute an associated cross-correlation for each time shifted data set, determine a phase error and phase score based on the time shifted data set that provides a maximum cross-correlation, determine a magnitude error and magnitude score using dynamic time warping of the maximum cross-correlation time shifted data set using a cost function based on distance and not based on slope between associated data points of the time shifted data set and the empirical test data, determine a slope error and slope score based on the maximum correlation time shifted data set and the empirical test data, and combine the phase score, the magnitude score, and the slope score to determine the objective metric for the computer model.

18. The computer system of claim 17 wherein the processor is configured to determine the slope error by:
dividing the maximum cross-correlation time shifted data set into multiple intervals each having a plurality of data points;
calculating an average of slopes corresponding to each interval; and
determining the slope error based on the average of slopes.

19. The computer system of claim 17 wherein the processor is further configured to perform auto-calibration of metric parameters associated with the objective metric by repeatedly comparing objective metric values calculated with an associated parameter set to a plurality of subjective ratings stored in the computer readable storage device and adjusting the metric parameters such that the objective metric value substantially matches a mean subjective rating.

20. The computer system of claim 17 wherein the phase, magnitude, and slope scores are determined based on corresponding phase, magnitude, and slope errors, respectively, and wherein the processor is configure to:
determine a score of zero if the corresponding error exceeds an associated parameter maximum threshold value;
determine a score of 100% if the corresponding error is less than an associated parameter tolerance threshold value; and
otherwise determine a score based on the corresponding error using a regression calculation.
